(19) United States
(12) Patent Application Publication
(10) Pub. No.: US 2004/0157761 A1
(43) Pub. Date: Aug. 12, 2004

(54) Encapsulated, defoaming bleaches and cleaning compositions containing them

(76) Inventors: Victor Fuk-Pong Man, St. Paul, MN (US); Melissa C. Meinke, Minneapolis, MN (US); Keith G. Lascotte, Maplewood, MN (US); Denise M. Chandler, St. Paul, MN (US)

Correspondence Address: MERCHANT & GOULD PC, P.O. BOX 2903, MINNEAPOLIS, MN, 55402-0903, US

(21) Appl. No.: 10/727,685

(22) Filed: Dec. 4, 2003

Related U.S. Application Data
(60) Provisional application No. 60/431,295, filed on Dec. 5, 2002.

(51) Int. Cl. C11D 3/00

(52) U.S. Cl. 510/302

(57) ABSTRACT

The present invention relates to an encapsulated bleach that is stable in solid alkaline cleaning compositions. The encapsulated bleach can also provide defoaming action to a cleaning composition. The present invention also relates to alkaline cleaning compositions including the inventive encapsulated bleach.

### CROSS REFERENCE TO RELATED APPLICATION

This application claims priority to U.S. Provisional Patent Application Serial No. 60/431,295 filed Dec. 5, 2002, the entire disclosure of which is incorporated herein by reference.

### FIELD OF THE INVENTION

The present invention relates to an encapsulated bleach that is sufficiently stable in solid alkaline cleaning compositions. The encapsulated bleach can also provide defoaming action to a cleaning composition. The present invention also relates to alkaline cleaning compositions including the inventive encapsulated bleach.

### BACKGROUND OF THE INVENTION

Conventional encapsulated bleaches are often not sufficiently stable in solid caustic cleaning compositions. Typically, formulating such an encapsulated bleach in a solid alkaline cleaning composition results in release of the bleach and degradation of or reaction with the solid, which can occur during processing. Further, conventional encapsulated bleaches often do not sufficiently dissolve when, as part of a solid alkaline cleaning composition, they are mixed with water to form a use solution. There remains a need for an encapsulated bleach suitable for use in a solid alkaline cleaning composition.

### SUMMARY OF THE INVENTION

The present invention relates to an encapsulated bleach that is sufficiently stable in solid alkaline cleaning compositions. The encapsulated bleach can also provide defoaming action to a cleaning composition. The present invention also relates to alkaline cleaning compositions including the inventive encapsulated bleach.

In an embodiment, the encapsulated bleach of the present invention includes a core, with a source of active-halogen and an outer coating. The outer coating can include an alkyl phosphate ester, an alkyl sulfate ester, an alkyl carboxylate with 6 to 14 carbons, salt thereof, or a mixture thereof. The encapsulated bleach can also include an optional inner coating. The inner coating can include inorganic material. The inorganic material can include condensed phosphate, such as sodium tripolyphosphate, sodium sulfate, or a mixture thereof. The inner coating can also include an alkyl phosphate ester, an alkyl sulfate ester, an alkyl carboxylate with 6 to 14 carbons, salt thereof, or a mixture thereof. In an embodiment, the inner coating includes an alkyl carboxylate with 6 to 14 carbons. In an embodiment, the inner coating includes condensed phosphate, such as sodium tripolyphosphate, sodium sulfate, alkyl carboxylate with 6 to 14 carbons, salt thereof, or a mixture thereof. In an embodiment, the alkyl phosphate ester includes or is a mixture of alkyl phosphate mono and diesters and the alkyl group includes 12-20 carbons or salt thereof. In an embodiment, the alkyl carboxylate includes or is isononanoic acid or salt thereof.

In an embodiment, the present solid alkaline cleaning composition includes an effective cleaning amount of a source of alkalinity and an effective bleaching amount of the present encapsulated bleach. In an embodiment, the source of alkalinity includes sodium hydroxide. The present cleaning composition can also include builder, water, and other additives. In an embodiment, the builder includes a polyacrylate, a phosphinopolycarboxylate, a tripolyphosphate, or a combination thereof.

### DETAILED DESCRIPTION OF THE INVENTION

Definitions

As used herein, a solid cleaning composition refers to a cleaning composition in the form of a solid such as a powder, a flake, a granule, a pellet, a tablet, a lozenge, a puck, a briquette, a brick, a solid block, a unit dose, or another known solid form of a cleaning composition.

Amounts of ingredients stated in this patent application generally refer to the amount of the particular active ingredient (e.g., nonionic surfactant). Amounts stated for commercial products typically relate to the amount of the commercial product. The amount of active provided by the commercial product can be determined from the concentration of the commercial product and the fraction of the commercial product that is the active ingredient.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use compositions in the real world; through inadvertent error in these procedures; through differences in the manufacture, source, or purity of the ingredients employed to make the compositions or carry out the methods; and the like. Whether or not modified by the term “about”, it is intended that the claims include equivalents to the quantities.

Encapsulated Bleach

The present encapsulated bleach includes a core of an active halogen compound and at least one outer coating layer. The coating can include an alkyl phosphate ester or an alkyl sulfate ester and, optionally, an alkyl carboxylate, salt thereof, or mixture thereof. In an embodiment, the encapsulated bleach includes two coating layers. The inner coating layer can include inorganic material and, optionally, an alkyl carboxylate, salt thereof, or mixture thereof.

In an embodiment, the present coatings can provide advantageous dissolution of the encapsulated bleach for use of an alkaline, even caustic, cleaning composition. In an embodiment, the present compositions can provide low or no foaming, or can even prevent foaming by soils. In an embodiment, the present invention provides a high active chlorine level, for chlorinated caustic solid formulations, that produces no residue when dissolved at high concentrations and that has defoaming abilities on protein soils. Embodiments of the present encapsulated bleach can provide benefits in applications that require foam control and improved soil removal.

Halogen Source

The present encapsulated bleach includes a core of a known bleaching agent, such as an active halogen compound. The active halogen compound can, for example, be a source of a free elemental halogen or —OX—wherein X is Cl or Br, under conditions normally used in detergent-bleaching cleaning processes. In an embodiment, the active halogen compound releases chlorine or bromine species. In an embodiment, the active halogen compound releases chlorine.

Chlorine releasing compounds include potassium dichloroisocyanurate, sodium dichloroisocyanurate, chlorinated trisodiumphosphate, calcium hypochlorite, lithium hypochlorite, monochloramine, dichloroamine, [(monotrichloro)-tetra (monopotassium dichloro)]pentaisocyanurate, paratoluene sulfondichloro-amide, trichloromelamine, N-chlorammeline, N-chlorosuccinimide, N,N′-dichloroazodicarbonamide, N-chloro-acetyl-urea, N,N′-dichlorobiuret, chlorinated dicyandiamide, trichlorocyanuric acid, dichloroglycoluril, 1,3-dichloro-5,5-dimethyl hydantoin, 1-3-dichloro-5-ethyl-5-methyl hydantoin, 1-choro-3-bromo-5-ethyl-5-methyl hydantoin, dichlorohydantoin, salts or hydrates thereof, and mixtures thereof. In an embodiment, an chlorine releasing compound includes sodium dichloroisocyanurate. In an embodiment, an organic chlorine releasing compound can be sufficiently soluble in water to have a hydrolysis constant (K) of about 10⁻⁴ or greater.

The encapsulated bleach can include about 30 to about 90 wt-%, about 40 to about 90 wt-%, about 40 to about 99 wt-%, or about 50 to about 60 wt-%, about 85 to about 99 wt-%, halogen source. The encapsulated bleach can include about 70 wt-% or about 55 wt-% halogen source.

In an embodiment the bleach is an alkali metal salt of a chloroisocyanurate, a hydrate thereof, or a mixture thereof. Dichloroisocyanurate dihydrate, a suitable chlorine releasing compound, is commercially available. This compound can be represented by the formula:

NaCl₂C₃N₃O₃2H₂O

Outer Coating

The outer coating can include a low foaming or defoaming surfactant or surfactant mixture. In an embodiment the outer coating is sufficiently stable to bleach (e.g., hypochlorite) and alkalinity. The outer coating can include an alkyl phosphate ester, an alkyl sulfate ester, an alkyl carboxylate with 6 to 14 carbons, salt thereof, or mixture thereof.

Materials suitable for the outer coating include long chain alkyl phosphate esters, such as mixtures of mono and dialkyl phosphate esters or salt thereof. In an embodiment, the alkyl phosphate ester includes or is a mixture of alkyl phosphate mono and diesters and the alkyl group includes 12-20 carbons. In certain embodiments, the phosphate ester includes alkyl phosphate mono- and diester with 14 to 24 carbons in the alkyl group, e.g., 16 carbons. The encapsulated bleach can include an effective defoaming amount of long chain alkyl phosphate ester and/or an amount effective for forming a caustic and bleach resistant coating around the bleach. The encapsulated bleach can include about 0.2 to about 10 wt-%, about 0.2 to about 5 wt-%, about 0.5 to about 10 wt-%, about 0.5 to about 4 wt-%, about 0.5 to about 2 wt-%, about 1 to about 4 wt-% long chain alkyl phosphate ester. The encapsulated bleach can include about 1 wt-% or about 2 wt-% long chain alkyl phosphate ester. The composition can include any of these ranges or amounts not modified by about.

Materials suitable for the outer coating include long chain alkyl sulfate esters, such as mixtures of mono and dialkyl sulfate esters or salt thereof. In an embodiment, the alkyl sulfate ester includes or is a mixture of alkyl sulfate mono and diesters and the alkyl group includes 12-20 carbons. In certain embodiments, the sulfate ester includes alkyl sulfate mono- and diester with 14 to 24 carbons in the alkyl group, e.g., 16 carbons. The encapsulated bleach can include an effective defoaming amount of long chain alkyl sulfate ester and/or an amount effective for forming a caustic and bleach resistant coating around the bleach. The encapsulated bleach can include about 0.3 to about 10 wt-%, about 0.5 to about 5 wt-%, about 0.5 to about 2 wt-%, or about 1 to about 4 wt-% long chain alkyl sulfate ester. The encapsulated bleach can include about 1 wt-% or about 2 wt-% long chain alkyl sulfate ester. The composition can include any of these ranges or amounts not modified by about.

The outer coating can also include a hydrotrope. In an embodiment, the hydrotrope is low foaming hydrotrope or can participate in defoaming and is stable to bleach and alkalinity. In an embodiment, the outer coating includes an alkyl carboxylate with 8 to 16 carbons, 7 to 11 carbons, e.g., 8, 9, 10, 11, or 12 carbons. In an embodiment the alkyl carboxylate includes isononanoic acid or salt thereof (e.g., sodium or potassium salt). The encapsulated bleach can include an amount of the alkyl carboxylate effective for forming a caustic and bleach resistant coating around the bleach. The encapsulated bleach can include about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 5 (e.g. 4) wt-% or about 10 (e.g. 8) wt-% alkyl carboxylate. The composition can include any of these ranges or amounts not modified by about.

The encapsulated bleach can include about 0.5 to about 20 wt-%, about 1 to about 10 wt-%, about 2 to about 5 wt-%, about 0.5 to about 10 wt-%, about 1 to about 4 wt-%, about 1 to about 3 wt-%, about 1 to about 20 wt-%, about 1 to about 60 wt-%, about 2 to about 10 wt-%, or about 3 to about 7 wt-% of a mixture of alkyl carboxylate and long chain alkyl phosphate ester. The encapsulated bleach can include about 5 wt-% or about 2 wt-% of a mixture of alkyl carboxylate and long chain alkyl phosphate ester. The composition can include any of these ranges or amounts not modified by about.

The encapsulated bleach can include about 0.2 to about 10 wt-% long chain alkyl phosphate ester and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 0.2 to about 5 wt-% long chain alkyl phosphate ester and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 0.5 to about 10 wt-% long chain alkyl phosphate ester and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 0.5 to about 4 wt-% long chain alkyl phosphate ester and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 0.5 to about 2 wt-% long chain alkyl phosphate ester and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 1 to about 4 wt-% long chain alkyl phosphate ester and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate.

The encapsulated bleach can include about 1 wt-% long chain alkyl phosphate ester and about 5 (e.g. 4) wt-% or about 10 (e.g. 8) wt-% alkyl carboxylate. The encapsulated bleach can include about 2 wt-% long chain alkyl phosphate ester and about 5 (e.g. 4) wt-% or about 10 (e.g. 8) wt-% alkyl carboxylate. The composition can include any of these ranges or amounts not modified by about.

In such a mixture, the weight ratio of alkyl carboxylate:long chain alkyl phosphate ester can be about 2:1 to about 20:1. The weight ratio of alkyl carboxylate:long chain alkyl phosphate ester can be about 19:1, about 6:1, about 85:15, about 95:1, about 4:1, or about 3:1. The composition can include any of these ranges or amounts not modified by about.

The long chain alkyl phosphate ester can be effective for defoaming the cleaning composition and/or soil. The mixture of alkyl carboxylate and long chain alkyl phosphate ester can be effective for forming a caustic and bleach resistant coating around the bleach.

The encapsulated bleach can include about 0.5 to about 20 wt-%, about 1 to about 10 wt-%, about 2 to about 5 wt-%, about 0.5 to about 10 wt-%, about 1 to about 4 wt-%, about 1 to about 3 wt-%, about 1 to about 20 wt-%, about 1 to about 60 wt-%, about 2 to about 10 wt-%, about 3 to about 7 wt-%, or about 10 to about 60 wt-% outer coating. The encapsulated bleach can include about 5 wt-% or about 2 wt-% outer coating. The composition can include any of these ranges or amounts not modified by about.

In an embodiment, the outer coating remains sufficiently solid at temperatures likely to be encountered during storage of the product, for example, temperatures of about 15 to about 50° C., and also remains stable at temperatures likely to be encountered during processing of a product including the encapsulated bleach into end use mixtures, for example, temperatures of about 20 to about 95° C.

Inner Coating

The present encapsulated bleach can include an optional inner coating. The inner coating is between the active halogen core and the outer coating. In an embodiment, the inner coating provides a barrier or spacing between the chlorine core and the outer layer. The inner coating can include inorganic material. The inner coating can also include an alkyl phosphate ester, an alkyl sulfate ester, an alkyl carboxylate with 6 to 14 carbons, salt thereof, or a mixture thereof. Suitable alkyl phosphate esters, alkyl sulfate esters, and alkyl carboxylates are described hereinabove.

In an embodiment, the inner coating can include inorganic material and an alkyl carboxylate with 6 to 14 carbons. In an embodiment, the inner coating includes condensed phosphate, such as sodium tripolyphosphate, sodium sulfate, alkyl carboxylate with 6 to 14 carbons (e.g., isononanoic acid), salt thereof, or mixture thereof. The encapsulated bleach can include about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 5 (e.g. 4) wt-% or about 10 (e.g. 8) wt-% alkyl carboxylate. The composition can include any of these ranges or amounts not modified by about.

The inorganic material can include an inorganic filler, a builder, another soluble inorganic compound, or a mixture thereof that can form a coating on a particle of active halogen compound. The inorganic material can include condensed phosphate, such as sodium tripolyphosphate, sodium sulfate, or a mixture thereof.

The inner coating can include an inorganic fillers such as: an alkali (e.g., sodium carbonate, sodium bicarbonate, sodium sesquicarbonate, sodium borate, sodium tetraborate, potassium carbonate, potassium bicarbonate, potassium sesquicarbonate, potassium borate, and potassium tetraborate), a phosphate (e.g., forms of mono, di and trisodium phosphate, mono, di and tripotassium phosphate, anhydrous hydrated diammonium phosphate, diammonium phosphate, monocalcium phosphate monohydrate, tricalcium phosphate, calcium pyrophosphate, iron pyrophosphate, magnesium phosphate, monopotassium orthophosphate, potassium pyrophosphate, dry disodium orthophosphate dihydrate, trisodium orthophosphate decahydrate, tetrasodium pyrophosphate, sodium tripolyphosphate, sodium phosphate glass), a neutral soluble salt (e.g., sodium sulfate or sodium chloride), a silicate (e.g., a water soluble silicate having an SiO₂:Na₂O ratio of about 1.6-3.2), an organic sequestering agent, an antiredeposition agent, combinations thereof, or mixtures thereof.

In an embodiment, the inner coating includes a builder such as, for example, tetrasodium or tetrapotassium pyrophosphate, pentasodium or pentapotassium tripolyphosphate, a sodium trimetaphosphate, a sodium or potassium silicate (including anhydrous and hydrated forms), a hydrated or anhydrous borax (e.g. sodium borate), a sodium or potassium carbonate, a sodium or potassium bicarbonate, a sodium or potassium sesquicarbonate, a phytate, or a polyphosphonate, such as sodium or potassium HEDP, and the like, or a combination or mixture thereof.

The encapsulated bleach can include 15 to about 55 wt-%, about 15 to about 35 wt-%, about 20 to about 30 wt-%, about 25 to about 45 wt-%, or about 30 to about 40 wt-% inorganic material. The encapsulated bleach can include about 25 wt-% or about 35 wt-% inorganic material. The composition can include any of these ranges or amounts not modified by about.

The encapsulated bleach can include about 0 to about 60 wt-%, about 0 to about 50 wt-%, about 5 to about 60 wt-%, about 5 to about 50 wt-%, about 10 to about 55 wt-%, about 20 to about 30 wt-%, or about 40 to about 50 wt-% mixture of inorganic material and alkyl carboxylate. The encapsulated bleach can include about 25 wt-% or about 45 (e.g., 43) wt-% mixture of inorganic material and alkyl carboxylate. The composition can include any of these ranges or amounts not modified by about.

The encapsulated bleach can include about 15 to about 55 wt-% inorganic material and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 15 to about 35 wt-% inorganic material and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 20 to about 30 wt-% inorganic material and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 25 to about 45 wt-% inorganic material and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The encapsulated bleach can include about 30 to about 40 wt-% inorganic material and about 1 to about 15 wt-%, about 2 to about 10 wt-%, about 2 to about 25 wt-%, about 4 to about 6 wt-%, about 5 to about 15 wt-%, or about 6 to about 10 wt-% alkyl carboxylate. The composition can include any of these ranges or amounts not modified by about.

The encapsulated bleach can include about 25 wt-% inorganic material and about 5 (e.g. 4) wt-% or about 10 (e.g. 8) wt-% alkyl carboxylate. The encapsulated bleach can include about 35 wt-% inorganic material and about 5 (e.g. 4) wt-% or about 10 (e.g. 8) wt-% alkyl carboxylate. The composition can include any of these ranges or amounts not modified by about.

The phosphate ester can be effective for defoaming the cleaning composition and/or soil. Phosphate ester, alkyl carboxylate, inorganic material, or mixtures thereof can be effective for forming a caustic and bleach resistant coating around the bleach.

The encapsulated bleach can include about 0 to about 60 wt-%, about 0 to about 50 wt-%, about 5 to about 60 wt-%, about 5 to about 50 wt-%, about 10 to about 55 wt-%, about 20 to about 30 wt-%, or about 40 to about 50 wt-% inner coating. The encapsulated bleach can include about 25 wt-% or about 45 (e.g., 43) wt-% inner coating. The composition can include any of these ranges or amounts not modified by about.

In an embodiment, the inner coating can remain sufficiently solid at temperatures likely to be encountered during storage of the product, for example, temperatures of about 15 to about 50° C., and also remains stable at temperatures likely to be encountered during processing of a product including the encapsulated bleach into end use mixtures, for example, temperatures of about 20 to about 95° C.

Encapsulated Bleach Compositions

Some examples of representative constituent concentrations for the present encapsulated bleaches can be found in Table 1, in which the values are given in wt-% of the ingredients in reference to the total composition weight. In certain embodiments, the proportions and amounts in Table 1 can be modified by “about”.

TABLE 1
Compositional Ranges for Encapsulated Bleach

| Class of | The Class Includes, for | | | | | | | | |
|---|---|---|---|---|---|---|---|---|---|
| Ingredient | Example: | Wt-% | Wt-% | Wt-% | Wt-% | Wt-% | Wt-% | Wt-% | Wt-% |
| Halogen Source | CDB 56 | 30-90 | 30-90 | 30-80 | 45-65 | 50-90 | 60-80 | 70 | 55 |
| | (Dichloroisocyanurate | | | | | | | | |
| | Dihydrate) | | | | | | | | |
| Inner Coating | Sodium sulfate, Sodium | 0-60 | 10-55 | 20-60 | 35-55 | 10-40 | 15-35 | 25 | 43 |
| | Tripolyphosphate, | | | | | | | | |
| | optional Alkyl | | | | | | | | |
| | Carboxylate | | | | | | | | |
| Outer Coating | Alkyl Phosphate Ester, | 0.5-60 | 1-30 | 0.5-10 | 1-5 | 1-20 | 2-10 | 5 | 2 |
| | optional Alkyl | | | | | | | | |
| | Carboxylate | | | | | | | | |

Methods of Encapsulating Active Halogen Compounds

The coating or coatings can be applied by known methods for applying coatings to active halogen compounds. Such methods are described, for example, in U.S. Pat. Nos. 4,657,784, 4,681,914, 4,731,195, 4,830,773, 4,933,102, 5,213,705, 5,358,653, 5,407,598, and 6,589,443, the disclosures of which are incorporated herein by reference. The method of encapsulating can include methods employing a fluidized bed. The method of encapsulating can include methods that completely encapsulate the active halogen compound with a continuous coating, and produce free-flowing and nonagglomerated encapsulated bleaches. Advantageously, fully covering each particle prevents the active halogen compound from reacting with its surroundings, e.g., a solid alkaline cleaning composition.

Methods Employing Encapsulated Active Halogen Compounds

It is contemplated that the encapsulated active halogen compounds of the invention can be used in a broad variety of institutional, food industry, household, vehicle care, and other such applications. Some examples include vehicle cleaning, floor cleaning, surface cleaning, clean-in-place, machine ware washing, laundry, and a broad variety of other such applications. The present encapsulated bleaches can be employed for cleaning an article that would benefit from cleaning with a low or non-foaming, bleach-containing cleaner, for example, a solid chlorine cleaning or sanitizing composition. In certain embodiments, the present invention includes methods of cleaning in place or machine warewashing using the present encapsulated active halogen compounds.

The methods include making from the encapsulated bleach a concentrate, intermediate, and/or use composition. The intermediate concentration composition can be fed into a clean-in-place system, a warewashing machine, or laundry machine or stored in a day tank. The concentrate or intermediate composition can be diluted to a use composition for or during use. The methods can include applying the use composition to the article to be cleaned. In an embodiment, the use composition is sprayed onto the article to be cleaned. In these methods, the present composition provides less foam than conventional encapsulated bleach-containing compositions.

Solid Alkaline Cleaning Compositions Containing the Encapsulated Bleach

The encapsulated bleaches of the present invention are suitable for use in a variety of solid cleaning compositions, particularly alkaline solid cleaning compositions. The present encapsulated bleaches are stable in compositions including hydroxide salt, carbonate salt, bicarbonate salt, borate salt, amine, silicate, metasilicate, or the like as a source of alkalinity. For example, the present encapsulated bleaches can be employed in alkaline solid cleaning compositions based on sodium hydroxide, potassium hydroxide, sodium carbonate (e.g., E form solid), potassium carbonate, sodium silicate, sodium metasilicate, or the like as a source of alkalinity.

The present encapsulated bleach particles can be dispersed throughout the solid alkaline cleaning composition. Accordingly, the present bleaches can provide higher levels of encapsulated halogen bleach in standard highly caustic systems than conventional alkaline cleaners. For example, the present compositions can provide bleach levels of about 10 to about 20 wt-%, about 5 to about 15 wt-%, about 3 to about 10 wt-%, or about 1 to about 5 wt-% in a use composition. In certain embodiments, the present cleaning compositions can be dissolved in water at a level of up to about 20 wt-%, up to about 15 wt-%, up to about 10 wt-%, up to about 5 wt-%, or up to about 3 wt-%. In certain embodiments, the present cleaning compositions can be dissolved in water at a level of about 10 wt-%, about 5 wt-%, or about 3 wt-%.

The present encapsulated bleaches can be employed in any of a variety of known alkaline cleaning compositions. In particular, the present encapsulated bleaches can be employed in the cleaning compositions disclosed in U.S. Pat. Nos. 4,681,914, 4,569,781, RE32,818, 6,150,324, 6,156,715, 6,177,392, and 6,258,765, the disclosures of which are incorporated herein by reference.

The present encapsulated bleach particles can be advantageously employed in solid alkaline cleaning compositions to produce a low or non-foaming solid, alkaline bleaching and cleaning composition. The present composition can also defoam the soil it contacts. The present composition can be used for cleaning and destaining any area that benefits from low or no foaming during cleaning.

For example, the present encapsulated bleaches can be employed in an inventive low foaming alkaline cleaning composition. The present alkaline cleaning composition includes alkalinity source, builder and/or water conditioning agent, solidification agent, water, and the present encapsulated bleach. The present cleaning composition is low or non foaming. The present cleaning composition can include, for example, the following components.

In an embodiment, the present solid cleaning composition can include about 0.2 to about 70 wt-%, about 2 to about 80 wt-%, about 5 to about 60 wt-%, about 5 to about 80 wt-%, about 20 to about 30 wt-% encapsulated bleaching agent. In an embodiment the present solid cleaning composition can include about 10 wt-%, about 20 wt-%, about 25 (e.g., 26) wt-%, or about 30 (e.g., 29) wt-% encapsulated bleaching agent.

Source of Alkalinity

The present solid cleaning composition can include effective amounts of one or more inorganic detergents or alkalinity sources to enhance cleaning of a substrate and improve soil removal performance of the composition. The source of alkalinity can include an alkali metal salt, such as alkali metal carbonate, alkali metal hydroxide, alkali metal silicate (e.g., metasilicate), or the like; alkali metal borate, such as sodium or potassium borate, and the like; ethanolamines and amines; inorganic alkalinity source, such as alkali metal hydroxide or silicate (e.g., metasilicate), alkali metal carbonate, or the like; and other like alkaline sources. The quantity of alkalinity source can be sufficient to render the composition mildly alkaline.

Suitable alkali metal hydroxides include, for example, sodium or potassium hydroxide, e.g., sodium hydroxide. An alkali metal hydroxide may be added to the composition in a variety of forms, including for example in the form of solid beads, dissolved in an aqueous solution, or a combination thereof. Alkali metal hydroxides are commercially available as a solid in the form of prilled solids or beads having a mix of particle sizes ranging from about 12-100 U.S. mesh, or as an aqueous solution, as for example, as a 50 wt-% and a 73 wt-% solution.

Examples of useful alkaline metal silicates include sodium or potassium silicate (with a M₂O:SiO₂ ratio of 1:2.4 to 5:1, M representing an alkali metal) or metasilicate. Suitable alkaline metal silicates include sodium metasilicate.

In an embodiment, the present solid cleaning composition includes about 20 to about 70 wt-%, about 30 to about 65 wt-%, or about 40 to about 60 wt-% source of alkalinity. In an embodiment, the present solid cleaning composition can include about 50 (e.g., 53) or about 55 (e.g., 53) wt-% source of alkalinity.

Sequestrant/Builder

The present solid cleaning composition can include a sequestrant or builder. In general, a sequestrant is a molecule capable of coordinating (i.e., binding) the metal ions commonly found in natural water to prevent the metal ions from interfering with the action of the other detersive ingredients of a cleaning composition. Some chelating/sequestering agents can also function as a threshold agent when included in an effective amount. For a further discussion of chelating agents/sequestrants, see Kirk-Othmer, Encyclopedia of Chemical Technology, Third Edition, volume 5, pages 339-366 and volume 23, pages 319-320.

A variety of sequestrants or builders can be used in the present solid cleaning composition, including, for example, organic phosphonate, aminocarboxylic acid, condensed phosphate, inorganic builder, polymeric polycarboxylate, mixture thereof, or the like. Such sequestrants and builders are commercially available. In an embodiment, the present solid cleaning composition includes about 5 to about 60 wt-%, about 5 to about 40 wt-%, about 10 to about 20 wt-%, or about 5 to about 15 wt-% sequestrant or builder. In an embodiment, the present solid cleaning composition includes about 10 (e.g., 11) wt-% sequestrant or builder.

Suitable condensed phosphates include sodium and potassium orthophosphate, sodium and potassium pyrophosphate, sodium and potassium tripolyphosphate, sodium hexametaphosphate, and the like, e.g., the sodium salt, e.g., of pyrophosphate. A condensed phosphate may also assist, to a limited extent, in solidification of the composition by fixing the free water present in the composition as water of hydration. In an embodiment, the present solid cleaning composition includes as a builder, chelator, or sequestrant a condensed phosphate, such as tetrasodium pyrophosphate.

Polycarboxylates suitable for use as cleaning agents include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, polymaleic acid, polyfumaric acid, copolymers of acrylic and itaconic acid, phosphino polycarboxylate, and the like. Suitable polycarboxylates include polyacrylate, phosphino polycarboxylate, and the like.

In an embodiment, the present solid cleaning composition includes as sequestrant or builder condensed phosphate and polyacrylate, or another polymer, for example, sodium tripolyphosphate and polyacrylate. In an embodiment, sodium salts of condensed phosphates are preferred to the corresponding potassium salts. In an embodiment, the present solid cleaning composition includes as sequestrant or builder polycarboxylates, such as polyacrylate and/or phosphino polycarboxylate.

The builder can include an organic phosphonate, such as an organic-phosphonic acid and alkali metal salts thereof. Some examples of suitable organic phosphonates include: 1-hydroxyethane-1,1-diphosphonic acid: CH₃C(OH)[PO(OH)₂]₂; aminotri(methylenephosphonic acid): N[CH₂PO(OH)₂]₃; aminotri(methylenephosphonate), sodium salt

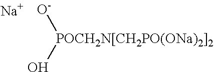

2-hydroxyethyliminobis(methylenephosphonic acid): HOCH₂CH₂N[CH₂PO(OH)₂]₂; diethylenetriaminepenta(methylenephosphonic acid): (HO)₂POCH₂N[CH₂CH₂N[CH₂PO(OH)₂]₂]₂; 2-phosphonobutane-1, 2, 4-tricarboxylic acid; diethylenetriaminepenta(methylenephosphonate), sodium salt: C₉H₍₂₈₋ₓ₎N₃Na_{X}O₁₅P₅ (x=7); hexamethylenediamine(tetramethylenephosphonate), potassium salt: C₁₀H₍₂₈₋ₓ₎N₂KₓO₁₂P₄ (x=6); bis(hexamethylene)triamine(pentamethylenephosphonic acid): (HO₂)POCH₂N[(CH₂)₆N[CH₂PO(OH)₂]₂]₂; and phosphorus acid H₃PO₃; and other similar organic phosphonates, and mixtures thereof.

Suitable organic phosphonates include PBTC, ATMP, and DTPMP.

The sequestrant can be or include aminocarboxylic acid type sequestrant. Suitable aminocarboxylic acid type sequestrants include the acids or alkali metal salts thereof, e.g., amino acetates and salts thereof. Some examples include the following:

N-hydroxyethylaminodiacetic acid;

hydroxyethylenediaminetetraacetic acid, nitrilotriacetic acid (NTA);

ethylenediaminetetraacetic acid (EDTA);

N-hydroxyethyl-ethylenediaminetriacetic acid (HEDTA);

diethylenetriaminepentaacetic acid (DTPA); and

alanine-N,N-diacetic acid;

and the like; and mixtures thereof.

Suitable aminocarboxylates include ethylenediamine tetraacetic acid (EDTA), diethylenetriamine pentaacetic acid (DTPA), their alkali metal salts, and mixtures thereof.

Solidification Agent

The solidification agent in the present cleaning compositions participates in maintaining the compositions in a solid form. Although other components of the solid composition may also be solids, the solidification agent can maintain the overall composition including solid and liquid components in a solid form. In an embodiment, the solidification agent can assist the source of alkalinity in maintaining the solid cleaning composition in solid form.

Suitable solidification agents include a solid polyethylene glycol (PEG), a solid EO/PO block copolymer, and the like; an amide, such as stearic monoethanolamide, lauric diethanolamide, an alkylamide, or the like; starches that have been made water-soluble through an acid or alkaline treatment process; celluloses that have been made water-soluble; an inorganic agent, such as, sodium hydroxide (e.g., caustic hydrate), a carbonate-based solidification agent (e.g. an E-form or sodium carbonate), sodium acetate, sodium sulfate, alkali metal phosphates (e.g., STPP, TKPP, and TSPP), silicates, such as sodium silicate and sodium metasilicate, or the like; poly(maleic anhydride/methyl vinyl ether); polymethacrylic acid; other generally functional or inert materials with high melting points; various inorganics that impart solidifying properties to a heated composition upon cooling; and the like.

In certain embodiments, the solidification agent includes solid PEG, for example PEG 1500 up to PEG 20,000. In certain embodiments, the PEG includes PEG 1450, PEG 3350, PEG 4500, PEG 8000, PEG 20,000, and the like. Additional suitable solidification agents include EO/PO block copolymers such as those sold under the tradenames Pluronic 108, Pluronic F68; amides such as lauric diethanolamide or cocodiethylene amide; and the like. In certain embodiments, the solidification agent includes a combination of solidification agents, such as combination of PEG and an EO/PO block copolymer (such as a Pluronic) and combination of PEG and an amide (such as lauric diethanol amide or stearic monoethanol amide).

In an embodiment, for more controlled dispensing, the solidification agent is not an extremely water soluble solid, such as urea. In this embodiment, other disfavored solidification agents include other hygroscopic solids.

Low Foaming/Defoaming Solid Alkaline Cleaning Compositions With Encapsulated Bleach

Some examples of representative constituent concentrations for the present solid cleaning compositions can be found in Table 2, in which the values are given in wt-% of the ingredients in reference to the total composition weight. In certain embodiments, the proportions and amounts in Table 2 can be modified by “about”.

TABLE 2
Compositional Ranges for Low Foaming Alkaline
Solids With Encapsulated Bleach

| Class of | The Class | | | | |
|---|---|---|---|---|---|
| Ingredient | Includes: | Wt-% | Wt-% | Wt-% | Wt-% |
| Alkalinity | NaOH, KOH | 20-70 | 30-65 | 40-60 | 53 |
| Source | | | | | |
| Builders/Water | Polyacrylates, | 5-60 | 5-40 | 10-20 | 11 |
| Conditioning | Tripolyphos- | | | | |
| Agents | phates, | | | | |
| | Polymers | | | | |
| Encapsulated | | 0.2-70 | 5-60 | 20-30 | 26 |
| Bleaching | | | | | |
| Agent | | | | | |
| Water | | 5-20 | 7-17 | 8-12 | 10 |

Some suitable concentrations of representative constituents for the present solid cleaning compositions can be found in Table 3, in which the values are given in wt-% of the ingredients in reference to the total composition weight. In certain embodiments, the proportions and amounts in Table 3 can be modified by “about”.

TABLE 3
Compositional Ranges for Low Foaming Alkaline
Solids With Encapsulated Bleach

| Class of Ingredient | The Class Includes: | Wt-% | Wt-% | Wt-% | Wt-% |
|---|---|---|---|---|---|
| Alkalinity Source | NaOH, KOH | 20-70 | 30-65 | 40-60 | 53 |
| Builders/Water | Polyacrylates, | 5-60 | 5-40 | 10-20 | 13 |
| Conditioning | Tripolyphosphates, | | | | |
| Agents | Polymers | | | | |
| Encapsulated | Chlorine source | 0.2-36 | 5-40 | 10-20 | 14 |
| Bleaching Agent | | | | | |
| | Inner Coating | 0.025-20 | 1-15 | 5-10 | 8 |
| | (optional) | | | | |
| | Outer Coating | 0.005-12 | 1-10 | 3-7 | 5 |
| Water | | 5-20 | 7-17 | 8-12 | 10 |

Additives

Solid cleaning compositions according to the invention can also include additional functional materials or additives that provide a beneficial property, for example, to the composition in solid form or when dispersed or dissolved in an aqueous solution, e.g., for a particular use. Examples of conventional additives include one or more of each of salt, rinse aid composition, softener, pH modifier, anti-corrosion agent, solubility modifier, detergent filler, anti-redeposition agent, antimicrobial, rinse aid composition, threshold agent or system, aesthetic enhancing agent (i.e., dye, odorant, perfume), optical brightener, lubricant composition, enzyme, effervescent agent, other such additives or functional ingredients, and the like, and mixtures thereof.

Adjuvants and other additive ingredients will vary according to the type of composition being manufactured, and the intended end use of the composition. In an embodiment, the composition includes as an additive antimicrobial.

Concentrate and Use Compositions

The solid cleaning composition according to the present invention can be suspended or dissolved in water to form a concentrate or intermediate composition. The present cleaning composition can be dissolved in water to form a use composition. For example, a dispenser can spray the solid composition with water to form a concentrate, intermediate, or use composition. That composition can collect in a day tank, from which it can be fed into a use site, such as a clean-in-place system. That composition can be delivered from the dispenser to the site of use. At the site of use, the concentrate or intermediate concentration can be diluted to form the use composition. Alternatively, the present solid cleaning composition can be added to or mixed with sufficient water to form a use composition without forming a concentrate composition. For example, the solid cleaning composition can be diluted directly with water to form a use composition.

The concentrate composition can include about 1 to about 20 wt-%, about 2 to about 15 wt-%, or about 5-15 wt-% of the solid cleaning composition. The use composition can include about 0.01 to about 3 wt-%, about 0.1 to about 2.5 wt-%, or about 0.3 to about 2 wt-% of the solid cleaning composition.

Processing of the Composition

Any of a variety of known methods for casting, extruding, or otherwise processing solid cleaning compositions can be employed for processing the present composition. For example, a broad variety of mixing, forming, casting, molding, extruding, and other such techniques may be used to form the solid composition in accordance with other embodiments of the invention.

In an embodiment, a suitable solid cleaning composition can be formed, for example, by: (i) mixing the source of alkalinity and solidification agent; (ii) heating, if necessary, to form a melt; (iii) blending in additional solid ingredients, such as builder or secondary solidification agent (if present); (iv) adding encapsulated bleach; and (v) cooling the composition to form a solid cleaning composition. The composition can be cast into a receptacle before complete solidification. Solidification of the composition can be accomplished by any conventional manner, such as cooling under room conditions, spraying with cold water, quenching in a cooling tank, or cooling in a refrigerated unit.

In an embodiment the ingredients can be mixed and extruded. The present compositions can be extruded by, for example, mixing the ingredients or premixes in order, and dispensing the mixed composition, e.g., into a container or shrink wrap. The mixture can be discharged from the mixing system through a die or other shaping apparatus and cut to a desired length. Alternatively, the molten mixture can be extruded into a shaped container and allowed to solidify.

Mixing for extrusion can include continuous mixing of the ingredients at high shear to form a substantially homogeneous liquid or semi-solid mixture in which the ingredients are distributed throughout its mass. The mixing system can include means for mixing the ingredients to provide shear or heat effective for maintaining the mixture at a flowable consistency. The mixture can be processed at a temperature to maintain the physical and chemical stability of the ingredients. The mixture can be processed at a temperature to keep the ingredients sufficiently liquid to flow and solid enough to harden. An ingredient can be in the form of a liquid or a solid such as a dry particulate, and may be added to the mixture separately or as part of a premix with another ingredient. One or more premixes may be added to the mixture. The temperature of the mixture when discharged from the mixing system can be sufficiently low to enable the mixture to be cast or extruded directly into shape that can be cut to the desired length without first cooling the mixture.

Packaging System

In some embodiments, the solid composition can be packaged. The packaging receptacle or container may be rigid or flexible, and composed of any material suitable for containing the compositions produced according to the invention, as for example glass, metal, plastic film or sheet, cardboard, cardboard composites, paper, and the like.

In an embodiment, the temperature of the processed mixture is low enough so that the mixture may be cast, molded or extruded directly into the container or other packaging system without structurally damaging the material. As a result, a wider variety of materials may be used to manufacture the container than those used for compositions that processed and dispensed under molten conditions.

In an embodiment, the packaging used to contain the compositions includes a rigid capsule.

Dispensing of the Processed Compositions

The cleaning composition made according to the present invention can be dispensed by any suitable method generally known. In an embodiment, the present solid cleaning composition is dissolved to form a use composition that is dispensed by spraying it onto or pumping it into the object to be cleaned.

The cleaning composition can be dispensed from a spray-type dispenser such as that disclosed in U.S. Pat. Nos. 4,826,661, 4,690,305, 4,687,121, 4,426,362 and in U.S. Pat. Nos. Re 32,763 and 32,818, the disclosures of which are incorporated by reference herein. Briefly, a spray-type dispenser functions by impinging a water spray upon an exposed surface of the solid composition to dissolve a portion of the composition, and then directing the concentrate or use solution including the composition out of the dispenser to a storage reservoir or directly to a point of use.

In some embodiments, the compositions hereof will be formulated such that during use in aqueous cleaning operations the wash water will have a pH of between about 7 and about 14, e.g., between about 7 and about 11.

Methods Employing the Present Compositions

It is contemplated that the present alkaline solids containing encapsulated bleach can be used in a broad variety of institutional, food industry, household, vehicle care, and other such applications. Some examples include surface cleaner, vehicle cleaning, floor cleaning, surface cleaning, clean-in-place, ware washing, laundry, and a broad variety of other such applications. The present alkaline cleaning compositions can be employed for cleaning an article that would benefit from cleaning with a low or non-foaming, bleach-containing cleaner, for example, a solid, defoaming chlorinated alkaline cleaner.

The methods include making from the alkaline cleaning composition a concentrate, intermediate, and/or use composition, and applying the use composition to the article to be cleaned. In an embodiment, the use composition is sprayed onto the article to be cleaned. In an embodiment, the intermediate composition is fed into a clean-in-place system, ware washing machine, or laundry machine. In these methods, the present composition can provide less foam than conventional alkaline encapsulated bleach-containing compositions, for example, when soil is present.

The present invention may be better understood with reference to the following examples. These examples are intended to be representative of specific embodiments of the invention, and are not intended as limiting the scope of the invention.

### EXAMPLES

Compositions

An example of the present encapsulated bleach composition was made and included:

TABLE 4

| | | Wt-% | Wt-% |
|---|---|---|---|
| Halogen | CDB 56 | 70 | 55 |
| Source | (Dichloroisocyanurate | | |
| | Dihydrate) | | |
| Inner | Sodium sulfate | 19 | 26 |
| Coating | Sodium Tripolyphosphate | 6 | 9 |
| | Alkyl Carboxylate | — | 8 |
| Outer | Alkyl Carboxylate | 4 | — |
| Coating | Alkyl Phosphate Ester | 1 | 2 |

The halogen source was, as required, screened to remove dust. The halogen source was then coated, for example, in a fluidized bed reactor, with a premix of the inner coating materials. After coating with the inner coating, the halogen source coated with the inner coating was coated with a premix of the outer coating.

Solid alkaline cleaning compositions of the present invention were made and included:

TABLE 5

| | | Wt-% | Wt-% |
|---|---|---|---|
| Alkalinity | NaOH bead | 48 | 43 |
| Source | NaOH, 50% solution | 9 | 9 |
| Builder | Sodium Polyacrylate | 8 | 7 |
| | Phosphino polycarboxylic | 5 | 5 |
| | Acid, 50% | | |
| Encapsulated | This Application | 26 | 29 |
| Bleaching Agent | | | |
| Soft Water | | 4 | 7 |

These compositions were made by mixing the ingredients other than the encapsulated bleach, cooling, adding the encapsulated bleach, and casting the composition into plastic capsules.

Soil Removal

Tables 6 and 7 show data demonstrating that the solid cleaning compositions according to the present invention exhibited superior soil removal compared to a comparable liquid cleaning composition.

The test reported in Table 6 was conducted with test soil including 5 grams of whole milk dried overnight on a stainless steel coupon. The soiled coupon was immersed in a use composition of the cleaning composition for 2.5 min without agitation and at 140° F.

TABLE 6
Soil Removal From Immersed Coupons Without Agitation

| | Concentration in | % Soil | Average % Soil |
|---|---|---|---|
| | Use Solution (wt-%) | Removed | Removed |
| Comparable | 0.4 | 88 | 85 |
| Liquid Cleaning | | 86 | |
| Composition | | 80 | |
| First Inventive | 0.1 | 96 | 96 |
| Solid Cleaning | | 94 | |
| Composition | | 97 | |
| Second Inventive | 0.1 | 95 | 96 |
| Solid Cleaning | | 96 | |
| Composition | | | |
| Water | | 82 | |

The data reported in Table 6 illustrate that the present solid cleaning compositions produced increased soil removal at lower concentrations compared to the conventional liquid cleaning composition.

The test reported in Table 7 was conducted with test soil baked on a stainless steel coupon. The soil included casein, clay, soap, and shortening. The soiled coupon was placed in the bottom of the tank of a Glewwe foam machine and contacted with churning use solution of the cleaning composition for 5 min at 160° F. with 6 psi of pressure circulating the use composition.

TABLE 7
Soil Removal From Coupons With Agitation

| | Concentration in | % Soil | Average % |
|---|---|---|---|
| | Use Solution (wt-%) | Removed | Soil Removed |
| Comparable | 0.4 | 81 | 79 |
| Liquid Cleaning | | 81 | |
| Composition | | 82 | |
| | | 73 | |
| Inventive Solid | 0.1 | 90 | 89 |
| Cleaning | | 90 | |
| Composition | | 84 | |
| | | 93 | |
| Inventive Solid | 0.07 | 88 | 82 |
| Cleaning | | 79 | |
| Composition | | 77 | |
| | | 89 | |
| Water | | 25 | |

The data reported in Table 7 illustrate that the present solid cleaning compositions produced increased soil removal at lower concentrations compared to the conventional liquid cleaning composition. For example, even at a concentration of 0.07 wt-% the present solid cleaning composition cleaned as well as or better than 0.4 wt-% of the conventional liquid.

Defoaming

Tables 8 and 9 show data demonstrating that the solid cleaning compositions according to the present invention exhibited foam reduction compared to a conventional cleaning composition including encapsulated bleach and compared to liquid cleaning compositions.

The tests reported in Tables 8 and 9 were conducted using a Glewwe foam machine with powdered milk as a source of foaming soil. The machine was running with milk soil until the foam stabilized. Then the cleaning composition was added and the machine ran for 5 min. The composition was maintained at 140° C. The foam machine produced foam in a cylinder. Decreases in the height of the foam in the cylinder indicated defoaming activity. The foam height was measured after the machine had been run for 5 min. Then, the foam machine was turned off. The foam height was measured again after the machine had been off for 30 sec.

TABLE 8
Defoaming Activity Reported as Inches of Foam With Comment

| | | +Milk | | −Milk | |
|---|---|---|---|---|---|
| | Grams | 5 min | +Milk | 5 min | −Milk |
| | of Milk | running | 30 sec off | running | 30 sec off |
| Powdered Milk | 1 | 8″ | 7.5″ | n/a | n/a |
| | | dense foam | | | |
| Inventive Solid | 1 | 5″ | 1″ | 0 | 0 |
| Cleaning | | | | | |
| Composition | | | | | |
| Powdered Milk | 0.5 | 8″ | 6.5″ | n/a | n/a |
| | | large bubbles | | | |
| Inventive Solid | 0.5 | 2″ | 0.1″ | 0 | 0 |
| Cleaning | | very large | breaks fast | | |
| Composition | | bubbles | | | |

The data reported in Table 8 illustrate that the present solid cleaning compositions was nonfoaming by itself and defoamed soil. For example, the present composition resulted in less foam during churning of the solution and faster disappearance of the foam after the foam machine was turned off.

TABLE 9
Defoaming Activity Reported as Inches of Foam and Comment

| | | +Milk | +Milk | −Milk | −Milk |
|---|---|---|---|---|---|
| | Wt-% | 5 min running | 30 sec off | 5 min running | 30 sec off |
| 2 g Powdered Milk | n/a | 8″ | 7.5″ | n/a | n/a |
| | | dense foam | no breaking | | |
| First Comparable | 0.4 | 8-8.5″ | 8″ | 0 | 0 |
| Liquid Cleaning | | dense foam | no breaking | | |
| Composition | | | | | |
| Second Comparable | 0.6 | 4.5″ | 1.5″ | 0.25 | 0 |
| Liquid Cleaning | | dense foam | fast | | |
| Composition | | | breaking | | |
| Third Comparable | 0.4 | 8-8.5″ | 8″ | 0.125 | 0 |
| Liquid Cleaning | | dense foam | no breaking | | |
| Composition | | | | | |
| Solid Containing | 0.1 | 9″ | 8.5″ | 2.5 | 1 |
| Conventional | | dense foam | no breaking | | |
| Encapsulated Bleach | | | | | |
| Solid Containing | 0.1 | 6″ | 2″ | 0 | 0 |
| Encapsulate with 1.5 | | large bubbles | slow | | |
| wt-% Outer Layer 1 — | | | breaking | | |
| Including Alkyl | | | | | |
| Phosphate Ester | | | | | |
| Solid Containing | 0.1 | 4.5″ | 1″ | 0 | 0 |
| Encapsulate with 3 | | large bubbles | fast | | |
| wt-% Outer Layer 1 — | | | breaking | | |
| Including Alkyl | | | | | |
| Phosphate Ester | | | | | |
| Solid Containing | 0.1 | 6″ | 2.5″ | 0 | 0 |
| Encapsulate with 1.5 | | large bubbles | slow | | |
| wt-% Outer Layer 2 — | | | breaking | | |
| Including Alkyl | | | | | |
| Phosphate Ester | | | | | |
| Solid Containing | 0.1 | 4″ | 0.5″ | 0 | 0 |
| Encapsulate with 3 | | large bubbles | fast | | |
| wt-% Outer Layer 2 — | | | breaking | | |
| Including Alkyl | | | | | |
| Phosphate Ester | | | | | |

The data reported in Table 9 illustrate that the present solid cleaning compositions was nonfoaming by itself and defoamed soil. For example, the present composition resulted in less foam during churning of the solution and faster disappearance of the foam after the foam machine was turned off.

Solution Stability

Table 10 shows data demonstrating that solid cleaning compositions according to the present invention produced relatively clear solutions at concentrations useful for concentrate compositions with no loss of chlorine. The comparable conventional composition produced much more precipitate.

TABLE 10
Solution Appearance With Inventive Solid Cleaning Composition

| Water | Hardness | Composition Wt-% | | | | | | |
|---|---|---|---|---|---|---|---|---|
| Type | (grain) | 1 | 1.5 | 2 | 2.5 | 3 | 7 | 10 |
| DI | 0 | clear | clear | clear | slight | hazy | turbid | clear |
| | | | | | haze | precipitate | precipitate | |
| City | 4 | n/a | n/a | n/a | n/a | hazy | turbid | hazy |
| | | | | | | precipitate. | precipitate | precipitate |
| Soft | 1 | n/a | n/a | n/a | n/a | slightly hazy | hazy | clear |
| | | | | | | precipitate | precipitate | |
| Well | 13 | n/a | n/a | n/a | n/a | hazy | turbid | hazy |
| | | | | | | precipitate | precipitate | precipitate |

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

We claim:

1. An encapsulated bleach comprising:
about 40 to about 99 wt-% core; the core comprising a source of active-halogen;
about 1 to about 60 wt-% outer coating; the outer coating comprising alkyl phosphate ester, alkyl sulfate ester, alkyl carboxylate with 6 to 14 carbons, salt thereof, or a mixture thereof.

2. The encapsulated bleach of claim 1, further comprising about 5 to about 50 wt-% inner coating; the inner coating comprising inorganic material.

3. The encapsulated bleach of claim 2, wherein the inner coating further comprises alkyl phosphate ester, alkyl sulfate ester, alkyl carboxylate with 6 to 14 carbons, salt thereof, or mixture thereof.

4. The encapsulated bleach of claim 3, wherein the inner coating comprises inorganic material and alkyl carboxylate with 6 to 14 carbons.

5. The encapsulated bleach of claim 3, wherein the alkyl carboxylate comprises a 7-11 carbon carboxylic acid salt.

6. The encapsulated bleach of claim 5, wherein the alkyl carboxylate comprises isononanoate.

7. The encapsulated bleach of claim 4, wherein the inner coating comprises sodium sulfate, sodium tripolyphosphate, and isononanoate.

8. The encapsulated bleach of claim 2, wherein the inner coating comprises builder.

9. The encapsulated bleach of claim 4, wherein the builder comprises tripolyphosphate.

10. The encapsulated bleach of claim 2, wherein the inner coating comprises inorganic salt.

11. The encapsulated bleach of claim 4, wherein the inorganic salt comprises sodium sulfate.

12. The encapsulated bleach of claim 1, wherein the outer coating comprises alkyl phosphate ester.

13. The encapsulated bleach of claim 6, wherein the alkyl phosphate ester comprises a mixture of alkyl phosphate mono and diesters and the alkyl group comprises 12-20 carbons.

14. The encapsulated bleach of claim 13, wherein the mixture of alkyl phosphate mono and diesters comprises a C₁₆-alkyl phosphate monoester and a C₁₆-alkyl phosphate diester.

15. The encapsulated bleach of claim 1, wherein the source of active halogen comprises a source of active chlorine.

16. The encapsulated bleach of claim 15, wherein the source of active chlorine comprises dichloroisocyanurate.

17. The encapsulated bleach of claim 2, comprising about 40 to about 90 wt-% core, about 5 to about 50 wt-% inner coating, and about 1 to about 30 wt-% outer coating.

18. The encapsulated bleach of claim 1, comprising about 85 to about 99 wt-% core and about 1 to about 15 wt-% outer coating.

19. A solid alkaline cleaning composition comprising:
about 20 to about 70 wt-% of a source of alkalinity; and
about 2 to about 80 wt-% of an encapsulated bleach comprising:
about 40 to about 99 wt-% core; the core comprising a source of active-halogen;
about 1 to about 60 wt-% outer coating; the outer coating comprising alkyl phosphate ester, alkyl sulfate ester, alkyl carboxylate with 6 to 14 carbons, salt thereof, or a mixture thereof.

20. The composition of claim 19, wherein the source of alkalinity comprises sodium hydroxide, potassium hydroxide, alkali metal borate, alkali metal carbonate, alkali metal silicate, amine, or mixture thereof.

21. The composition of claim 19, further comprising:
about 5 to about 60 wt-% builder; and
about 3 to about 20 wt-% water.

22. The composition of claim 21, wherein the builder comprises a polyacrylate, a phosphinopolycarboxylate, a tripolyphosphate, or a combination thereof.

23. The composition of claim 19, wherein the encapsulated bleach further comprises about 5 to about 50 wt-% inner coating; the inner coating comprising inorganic material.

24. The composition of claim 23, wherein the inner coating further comprises alkyl phosphate ester, alkyl sulfate ester, alkyl carboxylate with 6 to 14 carbons, salt thereof, or mixture thereof.

25. The composition of claim 24, wherein the inner coating comprises inorganic material and alkyl carboxylate with 6 to 14 carbons.

26. The composition of claim 19, having a form of powder, flake, granule, pellet, tablet, lozenge, puck, briquette, brick, solid block, or unit dose.
